(19) United States
(12) Patent Application Publication
(10) Pub. No.: US 2013/0333940 A1
(43) Pub. Date: Dec. 19, 2013

(54) POWER MODULE DEVICE, METHODS AND ASSEMBLIES USING THE DEVICE, AND POWER MODULE KIT

(71) Applicant: David Joseph Stencil, San Diego, CA (US)

(72) Inventor: David Joseph Stencil, San Diego, CA (US)

(21) Appl. No.: 13/834,450

(22) Filed: Mar. 15, 2013

Related U.S. Application Data
(60) Provisional application No. 61/660,333, filed on Jun. 15, 2012.

(51) Int. Cl. H02G 3/18

(52) U.S. Cl. CPC H02G 3/18
USPC 174/503

(57) ABSTRACT

A power module device that can be removably fastened to a convenient location on an article of furniture or another body. The device, when mounted, provides an electrical power socket at a location convenient to the user, even when resting on a couch, bed, or another article of furniture. In preferred embodiments, the power module device includes a clamp configured to removably secure the device in the desired location.

### CROSS-REFERENCE TO RELATED APPLICATION

This patent application claims priority to provisional U.S. Patent Application No. 61/660,333, filed on Jun. 15, 2012.

### FIELD OF THE INVENTION

The present invention relates generally to a power module device having at least one electrical socket. More specifically, this invention relates to a power module device having a fastening mechanism for removably securing the power module device to a body.

### BACKGROUND OF THE INVENTION

With the variety of handheld and laptop devices that require power sources (e.g., for charging or use), a convenient electrical receptacle is often not readily accessible when on a couch, in a bed, on a chair, etc. Traditional solutions include using a loose extension cord, moving furniture to plug in the device, or both.

As just one example, when a person is sitting on a couch, to plug in a laptop, the most convenient option may be to find the nearest wall receptacle, which is often located behind furniture. An extension cord can provide access to the receptacle, but the cord, which may extend loosely across the floor in an unsecured manner, tends to be unattractive and cumbersome. Moreover, stretching a conventional power cable from the wall to a remote location can stress the ports on the outlet, or may leave the cable in a position where it can be tripped over easily.

Given the foregoing problems, it would be desirable to provide a power module device that can be mounted attractively and removably onto, for example, an article of furniture. Preferably, the power module device can be mounted at a convenient location on the article of furniture, ideally with little or no damage or modification to the furniture. Having an electrical outlet attractively mounted at a convenient location (e.g., on an article of furniture) would provide easy access to power, and could eliminate or better manage cables stretching across the room.

### SUMMARY OF THE INVENTION

Certain embodiments of the invention provide a power module device having a housing with a first active face. The first active face has a first electrical socket. In the present embodiments, the first active face lies generally in a first plane, such that to insert an electrical plug into the first electrical socket the plug can be moved toward and into the socket generally along an axis normal to the first active face. The power module device has a channel with an open mouth. In the present embodiments, the open mouth faces a direction generally orthogonal to the axis. Preferably, the fastening mechanism comprises a clamp configured to secure the power module device to a body when the body is received in the channel and clamped by the clamp. In certain combination embodiments, the invention provides a couch in combination with the power module device, which preferably is mounted on a lower front rail of the couch.

In some embodiments, the invention provides a power module device having a housing and a fastening mechanism. The fastening mechanism is configured to secure the power module device to an article of furniture. The housing has a first active face with a first electrical socket. In the present embodiments, the fastening mechanism has a front base, a rear base, and a channel located between the front and rear bases. The front base is closer to the active face of the housing than is the rear base. In the present embodiments, the rear base includes a first lance member configured to penetrate a fabric bottom liner of the article of furniture during mounting of the power module device onto the article of furniture. In certain combination embodiments, the invention provides a couch in combination with the power module device, which preferably is mounted on a lower front rail of the couch, e.g., such that the first lance member of the operatively mounted power module device penetrates the fabric bottom liner of the couch.

Certain embodiments of the invention provide a power module device having opposed front and rear sides. The device includes a housing having a first active face with a first electrical socket. In the present embodiments, the power module device has a fastening mechanism comprising a clamp that is configured to secure the power module device to an article of furniture, such as a lower front rail of a couch. In the present embodiments, the fastening mechanism includes an actuator located on the front side of the power module device (in some cases, located on the front of the housing). The actuator is configured such that rotating the actuator in a first direction causes the clamp to undergo a clamping operation in which a rear base of the clamp moves toward the housing, whereby a body of the article of furniture received in a channel of the clamp is clamped upon by the clamp. Preferably, the actuator is configured such that rotating the actuator in a second direction (which is different than the first direction, and may be an opposite direction) causes the clamp to undergo an unclamping operation in which a rear base of the clamp moves away the housing.

In certain combination embodiments, the invention provides a couch in combination with the power module device, which preferably is mounted on a lower front rail of the couch.

Some embodiments of the invention provide a kit comprising a power module device, a plurality of cable-securing tacks, and either or both of a removable cover plate and a decorative fabric facing configured to cover the housing. In the present embodiments, the power module device comprises a housing, a fastening mechanism, and an extension cable. The housing has an electrical socket. The fastening mechanism comprises a clamp configured to secure the power module device to a body of an article of furniture. The cable-securing tacks are configured to secure the extension cable to an underside of the article of furniture.

### BRIEF DESCRIPTION OF THE DRAWINGS

FIG. 1 is a partially broken-away perspective view of a power module device in accordance with one embodiment of the present invention.

FIG. 2 is another partially broken-away perspective view of the power module device of FIG. 1, shown from a different perspective than FIG. 1.

FIG. 3 is a front view of the power module device of FIG. 1.

FIG. 4 is a perspective view of a power module device in accordance with another embodiment of the invention.

FIG. 5 is a perspective view of the power module device of FIG. 4, shown from a different perspective than FIG. 4.

FIG. 6 is a front view of the power module device of FIG. 4.

FIG. 7 is another perspective view of the power module device of FIG. 4, shown from a different perspective than FIG. 4.

FIG. 8 is a side view of the power module device of FIG. 4.

FIG. 9 is a rear view of the power module device of FIG. 4.

FIG. 10A is a schematic partial section view of a power module device in accordance with still another embodiment of the invention.

FIG. 10B is a schematic rear view of the power module device of FIG. 10A.

FIG. 11 is a perspective view of an article of furniture having mounted removably thereto a power module device in accordance with yet another embodiment of the invention

FIG. 12 is a perspective detail view of the power module device mounted to the article of furniture of FIG. 11.

FIG. 13 is a schematic front view of a power module kit including a power module device, a plurality of cable-securing tacks, and a decorative fabric facing and/or a removable cover plate in accordance with still another embodiment of the invention

### DETAILED DESCRIPTION OF EXEMPLARY EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the given examples have many useful alternatives, which fall within the scope of the invention.

As stated above, with the variety of handheld and laptop devices that require power sources (e.g., for charging or use), a convenient receptacle is often not easily accessed when on a couch, in a bed, etc. The only solution at this point may be to use a loose extension cord, or to move furniture to plug in a device. The present invention solves this problem, and provides a power module device of particularly advantageous design.

The invention provides a power module device 10, methods of using the power module device, an article of furniture in combination with the power module device, and a kit comprising the power module device.

Certain embodiments of the invention provide a power module device 10 comprising a receptacle or housing 20 having an extension cable (or “cord”) 40 and being configured to be clamped onto a surface (which may be defined, for example, by a body of an article of furniture), so as to bring a power source to a convenient location (in front of a couch, at the side of a bedframe, on top of a nightstand, etc.). The extension cord 40 can then conveniently be positioned (and in some embodiments, secured) so as to remain safely out of sight. In certain embodiments, the device 10 then provides a removably (e.g., semi-permanently) mounted power source, which optionally is surge protected, and preferably provides power for both 120 volt and Universal Serial Bus (“USB”) devices.

Different embodiments of the power module device 10 are shown in the figures. The device 10 generally includes a housing 20 and a fastening mechanism 30. In the embodiments preferred currently, the device 10 also has an extension cable 40.

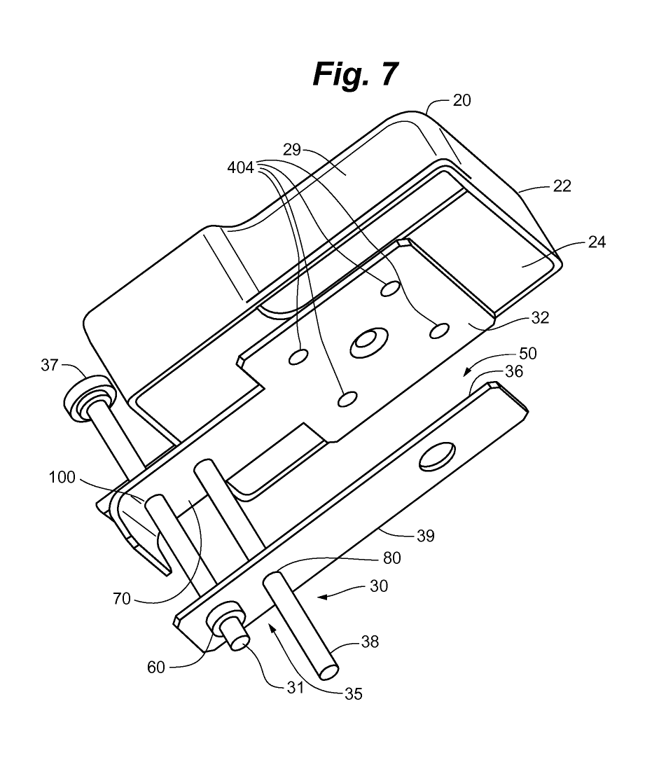

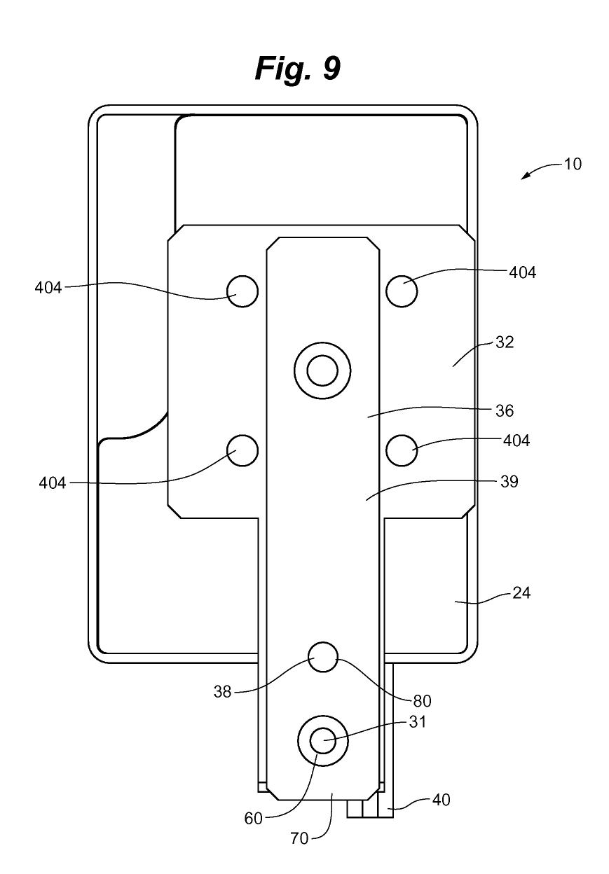

The housing 20 can be formed of a rigid material, such as plastic or metal. In certain embodiments, the housing 25 consists of plastic. The housing 20 can advantageously be an assembly of multiple housing sections. In some cases, the housing 20 is formed by assembling together a front housing section 22 and a back plate 24. One example of this is shown in FIGS. 7 and 9.

In the embodiments illustrated, the housing 20 surrounds an interior electrical equipment space. When operatively assembly, the housing 20 is equipped with (e.g., contains or encases) electrical components, including circuitry, wires, or both.

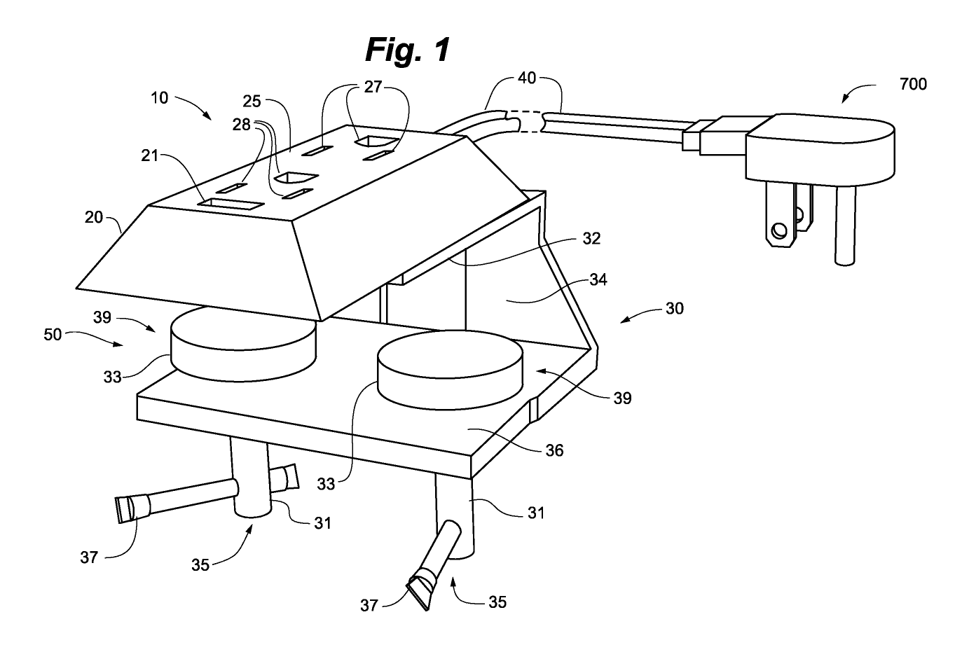

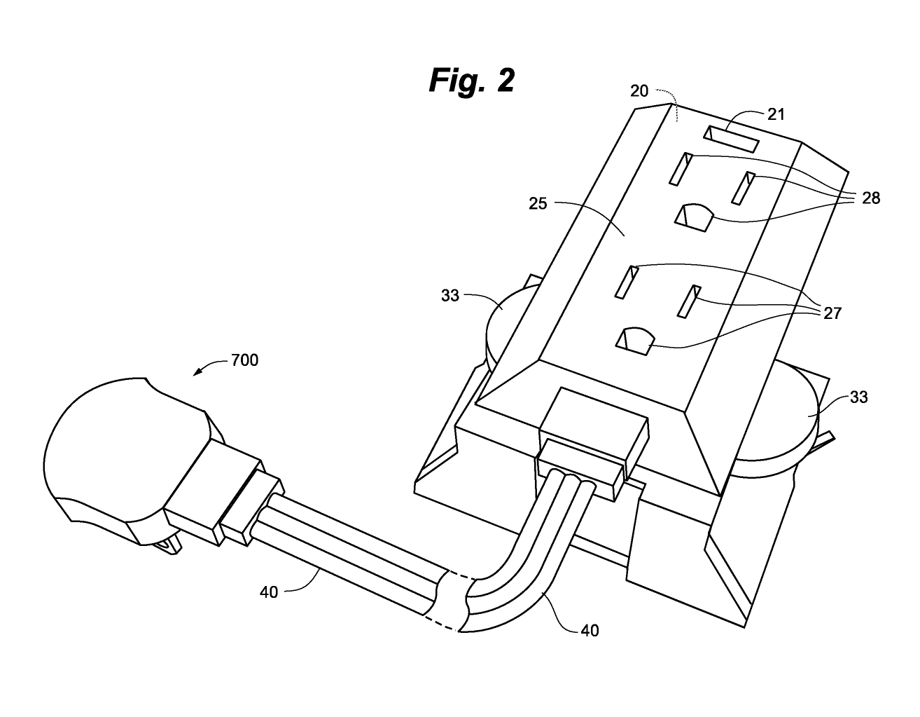

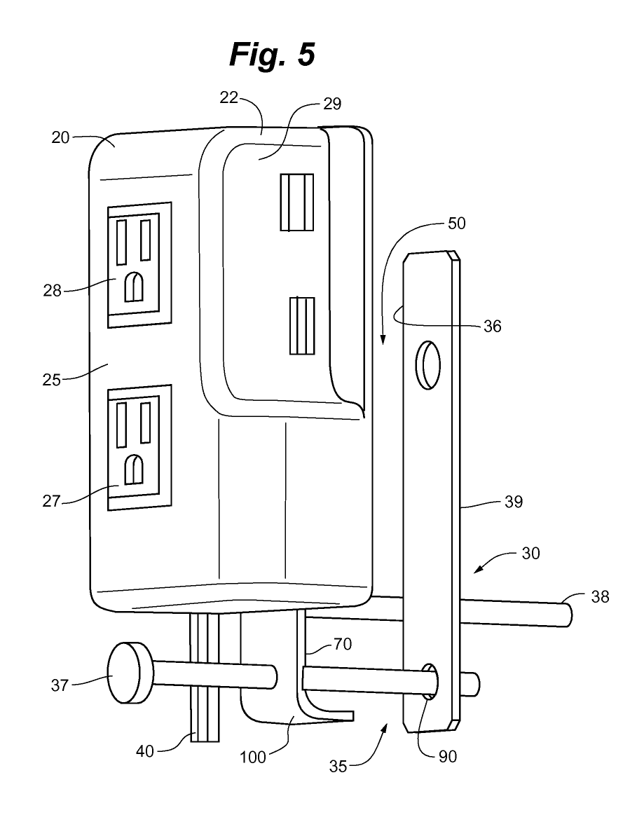

The housing 20 has a three dimensional geometric configuration, preferably comprising a plurality of (e.g., at least six, or at least seven) flat sides. Two such housing configurations are shown respectively in FIGS. 1-3 and FIGS. 4-9. If desired, the housing 20 can be a polyhedron. In some cases, the housing 20 has a generally cuboidal configuration, optionally being generally configured as a rectangular cuboid. This, however, is not required, as the housing can take many different shapes, including generally disk-shaped. If desired, the configuration of the housing can be designed so as to have design elements (rounded corners versus sharp corners, overall housing shape, etc.) that compliment a particular furniture type or style.

Preferably the housing 20 has a compact configuration. For example, the housing 20 can advantageously have an aspect ratio in the range of 0.33 to 3.0, preferably 0.4 to 2.5, and perhaps optimally 0.5 to 2. The aspect ratio is defined as being the width of the housing divided by the length of the housing. More will be said of this later.

As shown in the figures, the housing 20 has a first active face 25 with an electrical socket (“first socket”) 27. Preferably, this face 25 is on the front of the housing 20. In the embodiments illustrated, the first active face 25 lies generally in a first plane.

Thus, to insert an electrical plug into the first socket 27, the plug is moved toward and into the socket generally along an axis normal to the active face 25.

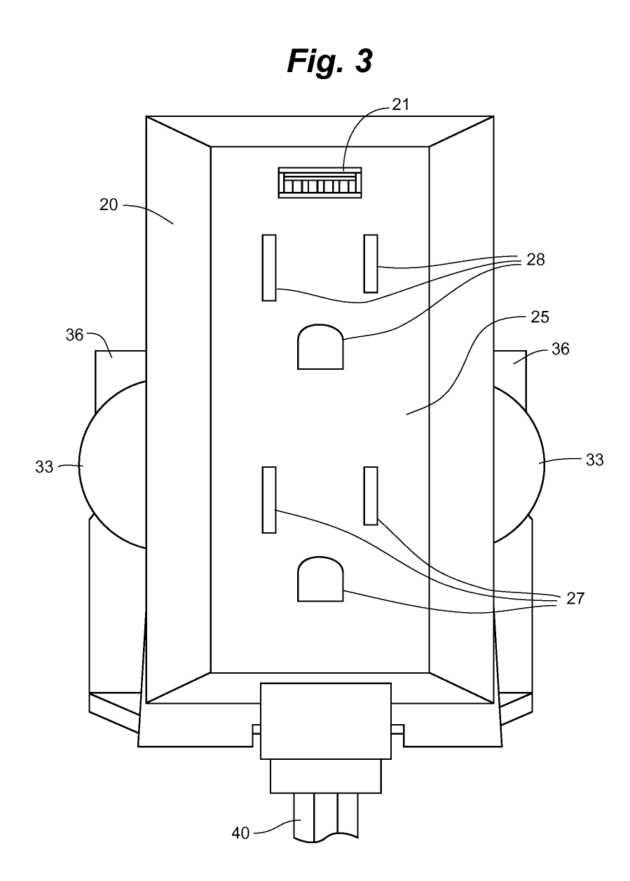

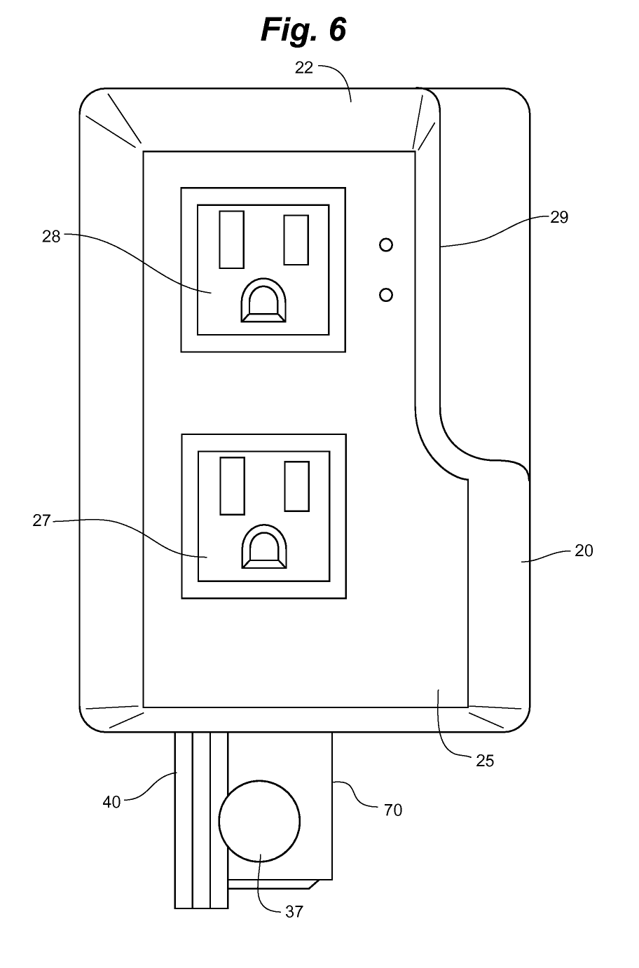

The first active face 25 preferably is defined by the housing 20, as is perhaps best seen in FIGS. 3 and 6. The noted electrical socket (“first socket”) 27 can optionally be an alternating current (“AC”) socket. If desired, the first active face 25 can have a plurality of electrical sockets, e.g., two or more AC sockets. Thus, the first active face 25 may further include a second electrical socket 28. In fact, more than two electrical sockets can be provided on the first active face 25, if so desired. In some embodiments, the first active face 25 has only 2-4 sockets, and perhaps optimally only two or three. One exemplary arrangement provides the first active face 25 with only two AC sockets, optionally together with at least one USB port. Reference is made to FIGS. 1-3. This arrangement, however, is by no means limiting to the invention.

Thus, the first active face 25 can advantageously include first and second electrical sockets 27, 28, and these sockets can optionally be spaced apart along, and centered on, a longitudinal axis of the housing 20. In the present disclosure, the length (or “height”) of the housing 20 is measured along the longitudinal axis, the width of the housing is measured along a lateral axis that lies generally in the above-noted first plane and that is perpendicular to the longitudinal axis. This manner of determining the length and width applies to the aspect ratio ranges noted above.

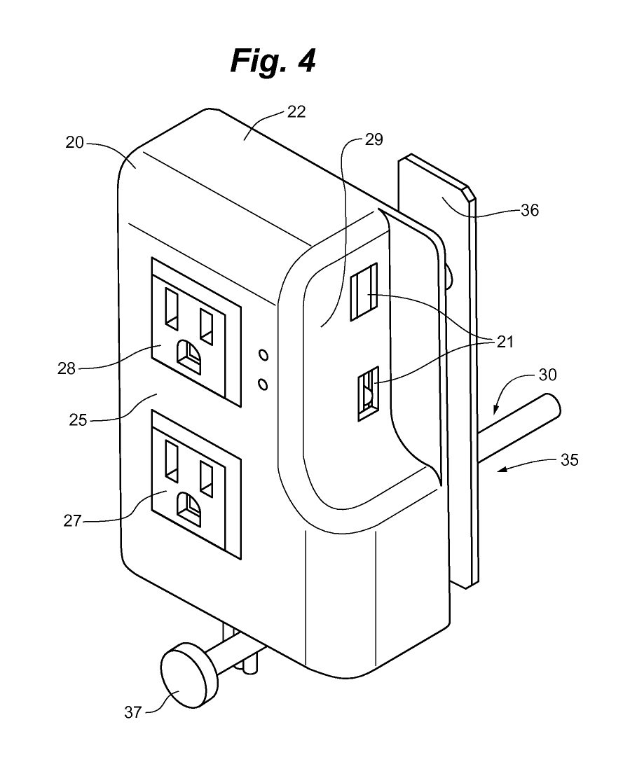

In some embodiments, the housing 20 further includes a second active face 29 with at least one electrical socket or port. FIGS. 4-9 depict an embodiment of this nature. Here, the second active face 29 is on a side of the housing 20, while the first active face 25 is on the front of the housing. Thus, the two active faces 25, 29, when provided, can optionally lie in planes that are generally perpendicular to each other. This, however, is not required. For example, the second active face can alternatively be an angled face that slopes away from the first active face at an acute angle. In another embodiment, the first active face is on the front of the housing, while the second active face is on the top of the housing. Typically, there will be no sockets or ports in the back of the housing, since the backside of the housing will typically be carried against a surface of an article of furniture of the like.

When two active faces are provided, the first active face 25 can optionally have a larger surface area than (in some cases, at least twice as great as) the second active face 29. As noted above, the first active face 25 preferably is on the front of the housing 20. In such cases, the first active face 27 may have one or more AC sockets, while the second active face 29 has one or more USB ports. In the embodiment of FIGS. 4-9, the first active face 25 has two AC sockets 27, 28, while the second active face 29 has two USB ports. Many different arrangements of this nature will be apparent to skilled artisans given the present disclosure as a guide.

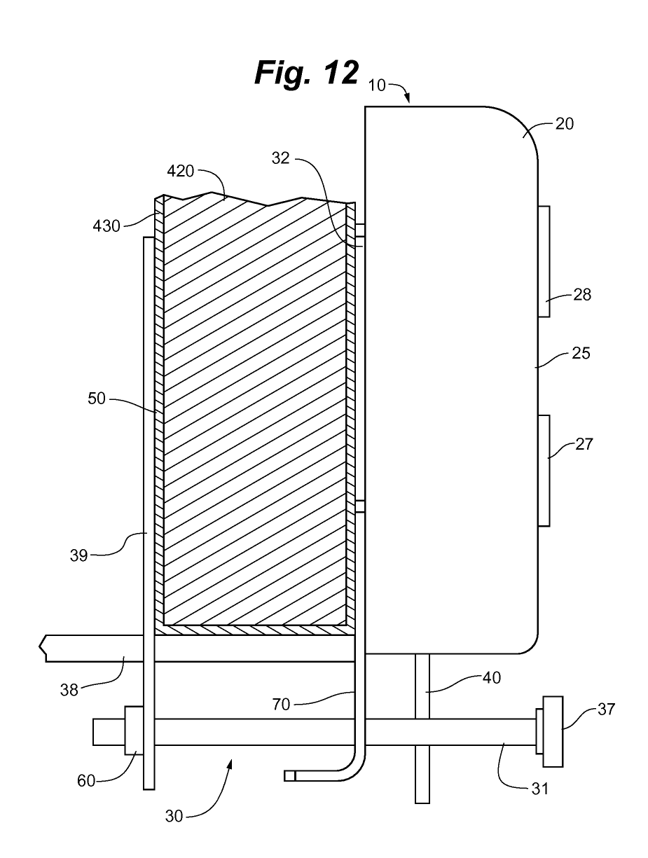

The fastening mechanism 30 of the power module device 10 is configured to secure the device 10 against a surface, e.g., onto a body, such as a furniture body (i.e., a body of an article of furniture). As just one example, the fastening mechanism 30 may be used to secure the power module device 10 to a lower front rail 406 of a couch 400. Reference is made to FIG. 11. The lower front rail 405 of a couch 400 commonly comprises a wooden board 420, typically faced with decorative fabric 430. Such a body can provide a convenient mounting spot for the power module device 10. It is to be understood, though, that the power module device can be mounted onto a wide variety of items (including various articles of furniture), and is by no means limited to use on furniture, much less on a couch.

The fastening mechanism 30 is configured to removably secure the power module device 10 onto a body comprising a piece of wood, metal, plastic, or another rigid member. Preferably, the fastening mechanism 30 is configured to secure the device 10 onto such a rigid member without damaging the wood, metal, plastic, or other rigid member. The fastening mechanism 30, for example, preferably does not use a screw or any other intrusive fastener that must penetrate, and thus leave a hole in, the wood, metal, plastic, or other rigid member. To accomplish this goal, various fastening mechanisms can be used.

In the embodiments illustrated, the power module device 10 has a mounting channel 50 with an open mouth. Preferably, the open mouth faces a direction generally orthogonal to the above-noted axis, which is normal to the plane in which the first active face 25 lies. It is advantageous to have the open mouth of the channel 50 face upwardly (e.g., generally toward the top of the device), since this enables the device 10 to be readily positioned on a downwardly facing rail (e.g., of an article of furniture or the like) by moving the open channel upwardly about the downwardly facing rail. The mounting channel 50 can thus be configured to receive a body (such as a lower front rail of a couch or another furniture body) onto which the device 10 is to be mounted. Preferably, the channel 50 has open sides, which are open to the open mouth. This can facilitate easy positioning of the device 10 onto a rail, table top, leg, or other body configured to fit within the channel 50.

In the currently preferred embodiments, the fastening mechanism 30 comprises a clamp 35. Referring to the figures, it can be appreciated that when a body (such as the lower front rail of a couch) is received in the channel 50 and clamped by the clamp 35, the power module device 10 is secured removably onto the body. In the illustrated embodiments, the invention securely and removably mounts the power module device (including the desired outlet(s)) to a surface using an attached C-clamp, which is easily moved to different positions on the surface, or removed from the surface, without damaging the surface.

When provided, the clamp 35 preferably comprises a jaw 39 movable selectively toward or away from the housing 20. In such cases, the movable jaw 39 has a clamped position and an unclamped position, and the movable jaw is closer to the housing 20 when in the clamped position than when in the unclamped position.

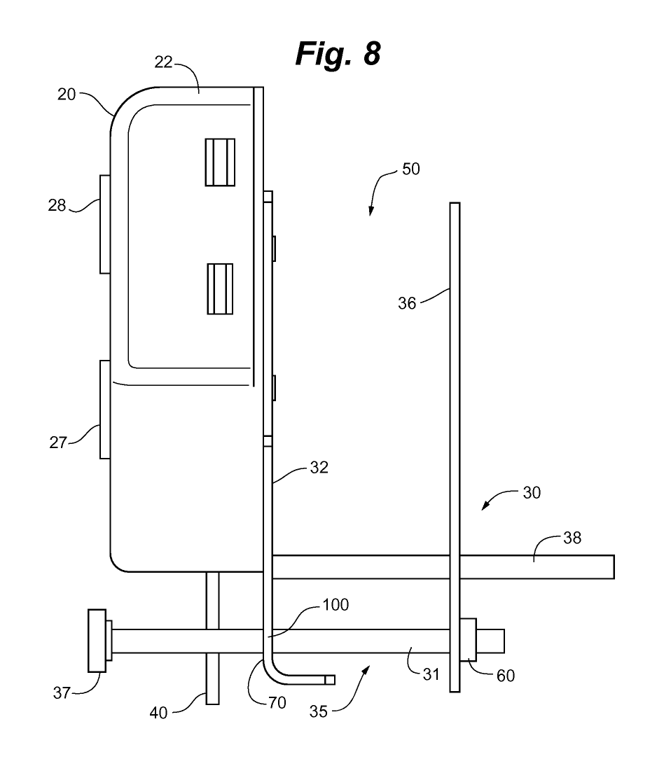

In the embodiments illustrated, the fastening mechanism 30 has a front base 32 and a rear base 36. The front base 32 is adjacent to the first active face 25 of the housing 20, while the rear base 36 is remote from the first active face 25 (e.g., the front base is closer to the first active face of the housing than is the rear base). This is perhaps best seen in FIGS. 1 and 8. Here, the channel 50 is located between (e.g., bounded by) the front 32 and rear 36 bases. It will generally be preferred that the front 32 and rear 36 bases be formed of metal, although they may be formed of plastic in some cases. If desired, the housing itself can define the front base.

In some embodiments, the fastening mechanism 30 is configured for being mounted removably to the housing 20 in at least two different orientations. For example, referring to FIGS. 7 and 9, it can be seen that four fasteners 404 secure the fastening mechanism 30 to the back of the housing 20. Due to the arrangement of these four externally threaded fasteners 404 and the four corresponding internally threaded bores in the back of the housing 20, the fastening mechanism can be mounted on the housing in four different orientations. For example, the fastening mechanism can be mounted on the housing in the orientation shown (such that the mouth of the channel generally faces upward, i.e., away from a top of the housing). If desired, the fastening mechanism 30 of FIGS. 4-9 can alternatively be mounted on the housing in a sideways fashion (such that the mouth of the channel generally faces sideways, i.e., away from a desired side of the housing). From FIGS. 7 and 9, it can be appreciated that the illustrated four-fastener configuration actually enables mounting the fastening mechanism 30 onto the housing 20 in any of four different orientations. This optional feature can also be provided in other embodiments of the device 10.

In the illustrated embodiments, the fastening mechanism 30 includes an actuator 37 and is configured such that: i) the jaw 39 moves toward the housing 20 in response to rotation of the actuator 37 in a first direction (e.g., clockwise or counterclockwise), and ii) the jaw 39 moves away from the housing 20 in response to rotation of the actuator 37 in a second direction.

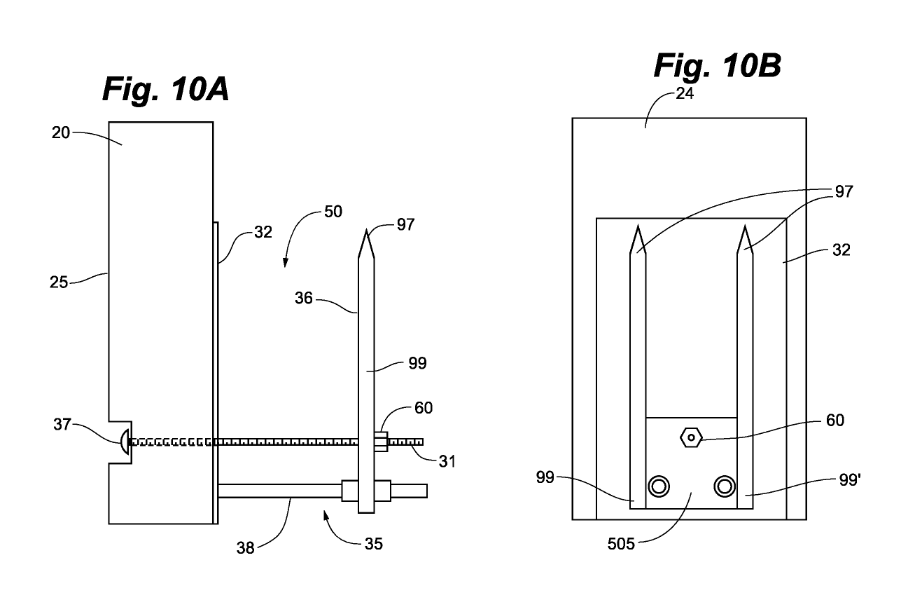

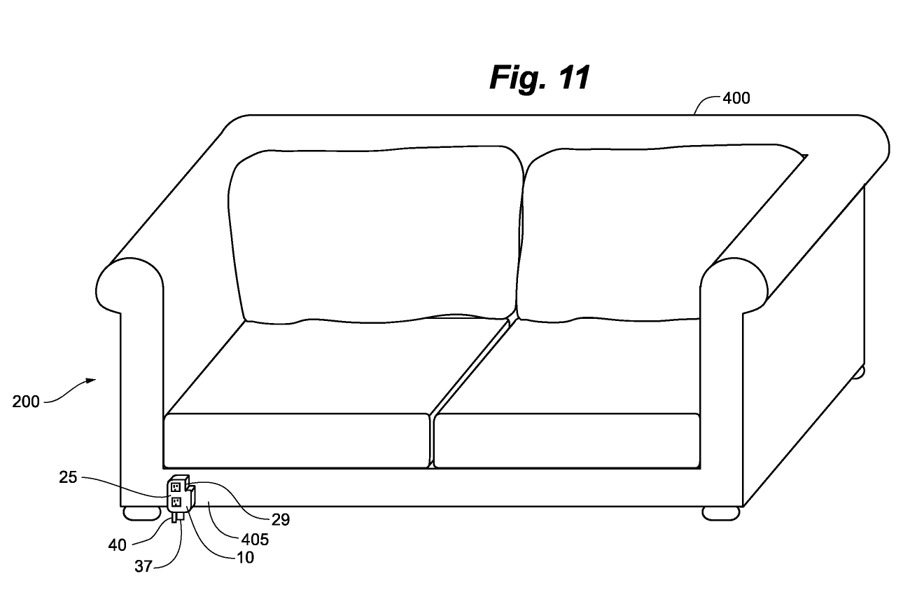

In the embodiment of FIGS. 4-9, the rotatable actuator 37 is conveniently located on the front (e.g., on or adjacent to the first active face 25) of the power module device 10. The same is true of the embodiment of FIGS. 10A and 10B. In both of these embodiments, the power module device 10 includes a clamp 35 that is actuated (e.g., clamped or unclamped) by a rotatable actuator 37 located on a front side of the device 10, and rotation of the actuator 37 in a first direction causes a jaw 39 of the clamp to move toward the housing 20. In FIGS. 4-9, the rotatable actuator 37 is located below (e.g., is spaced from) the bottom of the housing 20, although this is certainly not required. In FIGS. 10A and 10B, the rotatable actuator 37 is mounted on the front side of the housing 20.

The actuator 37 can advantageously be connected to, or comprise, an adjusting screw or another externally threaded adjusting shaft 31 that rotates to actuate the clamp 35. The embodiments of FIGS. 1-3, 4-9, and 10A-10B each include such an adjusting shaft 31.

In some cases, the jaw 39 comprises an adjusting shaft 31 and a contact head 33. One embodiment of this nature is shown in FIGS. 1-3. Here, the fastening mechanism 30 comprises two clamps 35, each having a jaw 39 movable selectively toward or away from the housing 20. In this particular embodiment, the two jaws 39 comprise two respective adjusting screws 37 configured to rotate and thereby cause the two respective contact heads 33 to move axially along two respective axes that are generally parallel to each other.

In FIGS. 1-3, the channel 50 is surrounded on three sides respectively by a bottom base 34, a front base 32, and a rear base 36. Here, the illustrated bottom base 34 is generally perpendicular to the noted first plane (in which the first active face 25 of the illustrated housing 20 lies).

In other embodiments, the clamp 35 comprises a jaw 39 that is defined by the rear base 36 of the fastening mechanism itself. In embodiments of this nature, the rear base 36 itself has a jaw 39 that is movable to affect clamping and unclamping of the fastening mechanism 30. One embodiment of this nature is shown in FIGS. 4-9; another is shown in FIGS. 10A and 10B. In FIGS. 4-9, the rear base 36 comprises (e.g., is) a plate that is movable selectively toward or away from the housing 20. In

FIGS. 10A and 10B, the rear base 36 comprises at least one lance 99. More will be said of this later.

In the embodiment of FIGS. 4-9, the fastening mechanism 30 includes a guide shaft 38 that is parallel to the adjusting shaft 31. Here, the adjusting shaft 31 is externally threaded and is mounted in an internally threaded bore 100 passing through a lower extension (e.g., a downwardly projecting flange) 70 of the power module device. The illustrated flange 70 is a downward extension of the fastening mechanism's front base 32. This is perhaps best seen in FIG. 7. Due to the threaded mating of the adjusting shaft 31 and bore 100, rotation of the shaft 31 causes it to move axially relative to the housing 20. This drives and controls the clamping and unclamping action of the movable jaw 39. In more detail, the plate that defines the movable jaw 39 is mounted to both the adjusting shaft 31 and the guide shaft 38. The movable jaw plate 29 is mounted on the guide shaft 38 for axial sliding movement along the guide shaft by virtue of a smooth (i.e., non-threaded) bore 80 in the movable jaw plate 39. In more detail, the distal end region of the adjusting shaft 38 is received in a smooth bore 90 in the bottom region of the movable jaw plate 39. A bearing lock 60 fixes the distal end region of the adjusting shaft 31 to the movable jaw plate 39 so as to provide free rotation of the adjusting shaft relative to the movable jaw plate, yet prevents the adjusting shaft from moving axially relative to the jaw plate. Thus, when the actuator 37 is rotated in a first direction, this causes the adjusting shaft 31 to rotate in the same direction. Due to the threaded engagement of the externally threaded adjusting shaft 31 and the internally threaded bore 100 in the bottom extension 70 of the front base 32, rotation of the adjusting shaft 31 in the first direction (e.g., clockwise) causes the movable jaw 39 to move away from the housing 20, thus affecting an unclamping motion. When the actuator 37 is rotated in a second direction (e.g., counterclockwise), the adjusting shaft 31 also rotates in the second direction and due to its threaded engagement with the bore 100 in the front base 32, the adjusting shaft moves axially so as to move the jaw 39 toward the housing 20. The guide shaft 38 serves to guide the jaw plate 39 and keep it upright during its clamping and unclamping movement.

FIGS. 10A and 10B exemplify advantageous embodiments wherein the power module device 10 is configured to be mounted to an article of furniture, and the device 10 (e.g., a fastening mechanism 30 thereof) includes a first lance member 99 configured to penetrate a fabric bottom liner of the article of furniture during mounting of the power module device onto the article of furniture. Here again, the housing preferably has a first active face 25 with a first electrical socket 27. The fastening mechanism 30 in these embodiments includes a front base 32, a rear base 36, and a channel 50 located between the front and rear bases. The front base 32 is closer to the active face 25 of the housing 20 than is the rear base 36.

In the present embodiments, the rear base 36 of the fastening mechanism 30 comprises a first lance member 99 configured to penetrate a fabric bottom liner of the article of furniture during mounting of the power module device onto the article of furniture. The first lance member 99 comprises an elongated rod having a sharp tip 97. While not strictly required, the rear base 36 shown in FIGS. 10A and 10B further includes a second lance member 99′, which is also configured to penetrate the fabric bottom liner of the article of furniture during mounting of the power module device onto the article of furniture. As shown in FIG. 10A, the first 99 and second 99′ lance members comprise two respective elongated rods that are generally parallel to each other and have two respective sharp tips 97. When provided, the lance 99 is configured to penetrate the fabric bottom liner of a couch with minimal visible damage. To improve “gripping performance,” the lance can optionally be provided with a rubberized coating, ripples, or both on its clamping surface.

Thus, in the particular embodiment of FIGS. 10A and 10B, the fastening mechanism 30 includes a clamp 35 configured to secure the power module device 10 to a body of the article of furniture when that body is received in the channel 50 and clamped by the clamp. And the clamp 35 here comprises two lance members 99, 99′ of the nature described above.

Actuation of the embodiment shown in FIGS. 10A and 10B can proceed in the same general manner described above with reference to the embodiment of FIGS. 4-9. In FIGS. 10A and 10B, however, there are two guide shafts 38, whereas in the embodiment of FIGS. 4-9 there is only one guide shaft 38. The actuator 37 here can optionally be rotated using an Allen key, which when rotated then moves the rear base 36 (including the lances 99, 99′) of the clamp 36 forward or backward, depending upon the direction of rotation.

Thus, it can be appreciated that FIGS. 4-9 and 10A-10B are representative of a group of particularly advantageous embodiments wherein the power module device 10 has a clamp 35 on a rear side of the device and an actuator 37 on a front side of the device. Embodiments of this nature are advantageous in that a person can conveniently control clamping and unclamping by simply manipulating the actuator on the front side of the device (e.g., on or adjacent to a front wall of the housing). It is therefore unnecessary to reach behind the device 10 to actuate the clamp. This makes it particularly easy to use the device 10 on a couch 400 or other articles of furniture 200 that would make reaching behind the device 10 less convenient.

Thus, the power module device 10 in the present embodiment group has front and rear sides. The device 10 includes a housing 20 having a first active face 25 with a first electrical socket 27. In the present embodiments, the device 10 has a fastening mechanism 30 comprising a clamp 35 that is configured to secure the device 10 to a body of an article of furniture 200, such as a lower front rail 405 of a couch 400. In the present embodiment group, the fastening mechanism 30 includes an actuator 37 located on the front side of the power module device 10 (in some cases, located on the front of the housing 20). Preferably, the actuator 37 is configured such that rotating the actuator in a first direction causes the clamp 35 to undergo a clamping operation in which a rear base 36 of the clamp moves toward the housing 20, whereby a body of the article of furniture 200 received in a channel 50 of the clamp is clamped upon by the clamp. Further, the actuator 37 preferably is configured such that rotating the actuator in a second direction (which is different than the first direction, and typically is an opposite direction) causes the clamp 35 to undergo an unclamping operation in which a rear base 36 of the clamp moves away the housing 20.

In the present embodiment group, a threaded rotatable adjusting shaft 31 can advantageously be provided to extend from the actuator 37 on the front side of the device 10 to a clamp 35 on the rear side of the device. In such cases, the adjusting shaft 31 preferably rotates in response to rotation of the actuator 37, and the rear base 36 of the clamp 35 preferably moves selectively toward or away from the housing 20 in response to rotation of the adjusting shaft 31.

If desired, the power module device 10 can include a decorative piece of fabric FB covering (or configured to cover) the housing 20. This does not require that the fabric FB be configured to cover the entire housing. Rather, the fabric FB may cover merely a portion of the housing, such as only the angled side walls of the housing 20 shown in FIGS. 1-3. The decorative piece of fabric FB can be affixed permanently or semi-permanently to the housing, or it can be mounted removably over the housing. If desired, the fabric may be adhered to the housing and/or clamped to the housing.

In some cases, the power module device includes a removable decorative cover plate CP. When provided, the cover plate CP can have a decorative color, pattern, or both. In some cases, when a cover plate CP is provided, it is configured to retain a decorative piece of fabric FB over the housing 20.

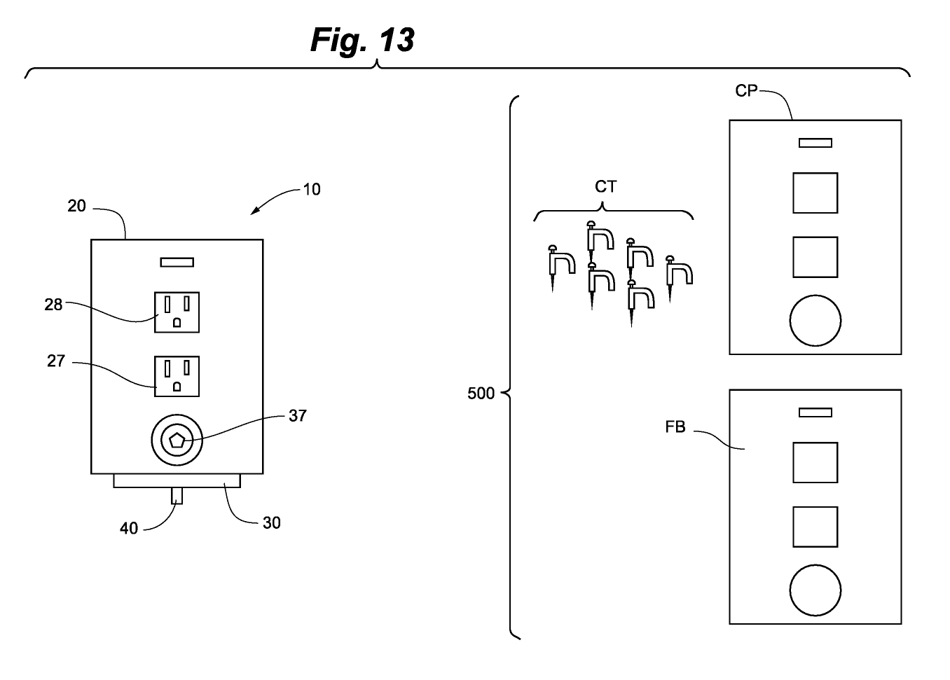

The invention also provides embodiments comprising the power module device 10 and an article of furniture 200 in combination. Reference is made to FIGS. 11 and 12, which show a couch 400 having mounted removably thereto the power module device 10. Here, the fastening mechanism of the device is secured (e.g., clamped) removably to a body of the couch. In this example, the device 10 is mounted to a lower front rail 405 of the couch 400. As shown in FIG. 12, a portion of the lower front rail 405 is received in the channel 50, and is clamped securely by the movable jaw 39. Note that the rail 405 here is not necessarily shown to scale (e.g., the relative thickness of the rail 405 would typically be smaller). In the embodiment illustrated, the lower front rail 405 comprises a board 420 that is faced with a decorative fabric 430. This, however, is merely one example of a suitable body to which the power module device 10 can be removably clamped.

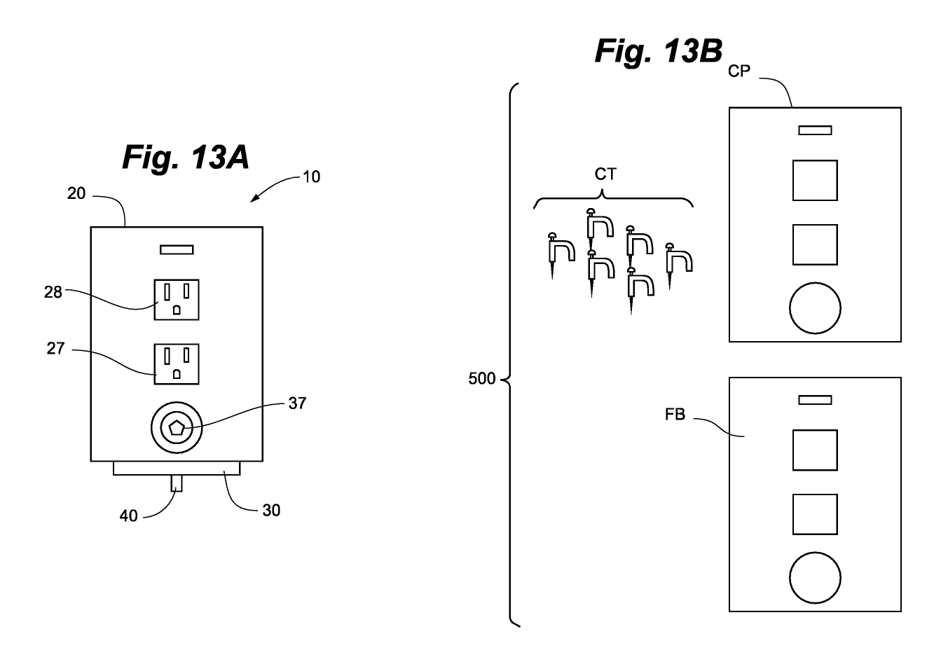

FIG. 13 is a perspective view of a power module kit 500 including a power module device 10, a plurality of cable-securing tacks 700, and either or both of a removable cover plate CP and a decorative fabric facing FB configured to cover the housing 20. The power module device 10 of the kit 500 includes a housing 20, a fastening mechanism 30, and an extension cable 40. The housing 20 has an electrical socket, and the fastening mechanism 30 includes a clamp 35 configured to secure the power module device 10 to a body of an article of furniture. The cable-securing tacks CT are configured to secure the extension cable 40 to an underside of the article of furniture. In some cases, the power module device 10 of the kit 500 includes a plurality of removable cover plates CP having different decorative colors, patterns, surface finishes, or both.

In certain preferred embodiments, the power module device 10 includes the following features:

1. C-clamp for mounting the device/receptacle/outlet to a surface

2. Surge protected receptacle with both 120V and USB power connections

3. Extension cable

4. Flat (90-degrees) wall plug

5. Optional furniture matched outlet cover plate

6. Cable-securing tacks

In some embodiments of this nature, the 90-degrees wall plug attaches to the outlet via an extension cable. With the outlet affixed to the C-clamp, you can semi-permanently mount the outlet to a surface. Cable tacks can be used to keep the excess extension cable safely out of sight by attaching it to the furniture. An optional cover plate can then be wrapped in matched fabric or provided with a wood surface, giving the outlet a nearly seamless appearance with its surrounding surface or fabric.

Thus, in some of the present embodiments, the flat wall plug 700 provides power to the entire unit while being able to keep your furniture close to the wall. The extension cable 40 can be stretched under the furniture, and then the device/receptacle/outlet mounted in any convenient position. The C-clamp can optionally be secured by using a tension bolt that applies pressure to the back of the mounting surface. The device/receptacle/outlet can then be secured into position, allowing access and easy plugging in/out of any device requiring power. The optional cover plate can give a custom appearance to the unit and help it match the surrounding or adjacent surface. When provided, the supplied tacks can be used to keep the adjacent power cable 40 affixed under the article of furniture 200 (e.g., to the underside of a couch 400), keeping the cable safely out of sight or in a desired position in the event of needing to move the furniture.

Thus, in some embodiments, and depending on the surface to which the device is to be mounted, the C-clamp would fit around an edge of the body defining the surface, and would be secure to the back side with an easy-to-turn tension bolt or the like. It may be hand tightened, and would remain in position until removal is desired. The extension cord 40 may be stretched under the furniture 200, and optionally secured with screw-mounted cable clips. The angled end would then plug into a wall receptacle. Everything for the consumer may be completely assembled, aside from potentially securing the optional cable clips and the optional cover plate. In some embodiments, the device 10 possesses the ability to turn at least one outlet 90 degrees to accommodate different mounting situations.

When provided, the C-clamp provides a secure mount that preferably causes no damage to the surface against which the device 10 is mounted, and it allows easy installation and removal. The angled wall plug is not a necessity to its function, but when provided can advantageously allow one to conveniently press furniture tighter to the wall when plugged in. The device/receptacle/outlet can be designed and provided in a variety of basic colors so as to be attractive without any further action. Optionally, the device 10 can include a fabric wrapped or wood textured cover plate that make the face of the device/receptacle/outlet blend in more seamlessly with the couch, table, or surface against which it is mounted. Additionally, the outlet can optionally be designed with built-in surge protection, helping guard against transient voltage.

In some embodiments, the C-clamp could be swapped (e.g., interchangeable) with a permanent mounting system. In such cases, the device 10 would not be removable (at least not without some damage), but would still provide a convenient outlet to the consumer/user. As noted above, the design shown in FIGS. 1-3 includes two 120 v outlets and a USB outlet for drawing power, while the design shown in FIGS. 4-9 includes two 120 v outlets and two USB outlets for drawing power. These configurations can be adjusted, of course, to accommodate international plugs.

Use of certain embodiments will now be described. One may begin by assessing the desired location of the device/receptacle/outlet. In some embodiments, it will be preferred to have a flat surface that can fit within the restrictions (e.g., within channel 50) of the C-clamp. One non-limiting example is a board on the lower front of a couch, e.g., a lower front rail 405 of a couch 400. Access from both sides is preferably available. If on a couch, a small incision of the fabric under the couch may need to be made. Next, one would slide the mount and C-clamp around the surface/body and set the device 10 into position, optionally by securing a tension bolt from the backside. Then, if desired, one may secure the extension cable 40 to the underside of the furniture 200 using cable clips, and finally plug the end of the extension cable into a wall receptacle before placing the furniture back into position. Once the outlet is secured and the furniture is in position, the system is ready for charging or powering the user's devices safely and easily.

The device 10 may be a PCB covered by a molded plastic clamshell. The clamp mechanism would then be attached via screws to complete the assembly.

While preferred embodiments of the present invention has been described, it should be understood that various changes, adaptations and modifications may be made therein without departing from the spirit of the invention and the scope of the appended claims.

What is claimed is:

1. A power module device having a housing with a first active face, the first active face having a first electrical socket, the first active face lying generally in a first plane, such that to insert an electrical plug into the first electrical socket the plug can be moved toward and into the socket generally along an axis normal to the first active face, the power module device having a channel with an open mouth, the open mouth facing a direction generally orthogonal to the axis, the fastening mechanism comprising a clamp configured to secure the power module device to a body when the body is received in the channel and clamped by the clamp.

2. The power module device of claim 1 wherein the channel has open sides, the open sides being open to the open mouth.

3. The power module device of claim 1 wherein the clamp comprises a jaw movable selectively toward or away from the housing.

4. The power module device of claim 3 wherein the jaw has a clamped position and an unclamped position, the jaw being closer to the housing when in the clamped position than when in the unclamped position.

5. The power module device of claim 3 wherein the fastening device includes an actuator and is configured such that: i) the jaw moves toward the housing in response to rotation of an actuator in a first direction, and ii) the jaw moves away from the housing in response to rotation of the actuator in a second direction.

6. The power module device of claim 3 wherein the jaw comprises an adjusting screw configured to rotate so as to cause the jaw to move selectively toward or away from the housing.

7. The power module device of claim 5 wherein the power module device has a front side and a rear side, the actuator being on the front side of the power module device, the clamp being on the rear side of the power module device, the actuator being configured such that: i) rotating the actuator in a first direction causes the clamp to undergo a clamping operation, and ii) rotating the actuator in a second direction causes the clamp to undergo an unclamping operation.

8. The power module device of claim 7 wherein the power module device includes a threaded rotatable adjusting shaft extending from the actuator on the front side of the power module device to the clamp on the rear side of the power module device.

9. The power module device of claim 8 wherein the power module device is configured such that the adjusting shaft rotates in response to rotation of the actuator, and the jaw of the clamp moves selectively toward or away from the housing in response to rotation of the adjusting shaft.

10. The power module device of claim 1 wherein the first active face has the first electrical socket, the power module device includes a second active face, and the second active face has a USB outlet.

11. The power module device of claim 1 wherein the power module device includes a surge protector.

12. The power module device of claim 1 wherein the power module device includes an extension cable.

13. The power module device of claim 1 wherein the active face further includes a second electrical socket, the first and second electrical sockets being spaced apart along, and centered on, a longitudinal axis, the housing having a width, a height, and an aspect ratio, the length of the housing being measured along the longitudinal axis, the width of the housing being measured along a lateral axis lying generally in the first plane and being perpendicular to the longitudinal axis, the aspect ratio being defined as the width divided by the height, the aspect ratio being between 0.4 and 2.5.

14. The power module device of claim 1 wherein the power module device is in combination with a couch having a lower front rail, the clamp of the power module device being clamped onto the lower front rail of the couch.

15. A power module device having a housing and a fastening mechanism, the fastening mechanism being configured to secure the power module device to an article of furniture, the housing having a first active face with a first electrical socket, the fastening mechanism having a front base, a rear base, and a channel located between the front and rear bases, the front base being closer to the active face of the housing than is the rear base, the rear base comprising a first lance member configured to penetrate a fabric bottom liner of the article of furniture during mounting of the power module device onto the article of furniture.

16. The power module device of claim 15 wherein the lance member comprises an elongated rod having a sharp tip.

17. The power module device of claim 15 wherein the rear base further includes a second lance member configured to penetrate the fabric bottom liner of the article of furniture during mounting of the power module device onto the article of furniture.

18. The power module device of claim 17 wherein the first and second lance members comprise two respective elongated rods being generally parallel to each other and having two respective sharp tips.

19. A kit comprising a power module device, a plurality of cable-securing tacks, and either or both of a removable cover plate and a decorative fabric facing configured to cover the housing, the power module device comprising a housing, a fastening mechanism, and an extension cable, the housing having an electrical socket, the fastening mechanism comprising a clamp configured to secure the power module device to a body of an article of furniture, the cable-securing tacks being configured to secure the extension cable to an underside of the article of furniture.

20. The kit of claim 19 wherein the power module device includes a plurality of removable cover plates having different decorative colors, patterns, surface finishes, or both.
